(19) United States
(12) Patent Application Publication
(10) Pub. No.: US 2004/0236508 A1
(43) Pub. Date: Nov. 25, 2004

(54) In-vehicle device and method for restraining unauthorized use

(75) Inventor: Akihiro Ogasawara, Toyokawa-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/824,500

(22) Filed: Apr. 15, 2004

(30) Foreign Application Priority Data
May 22, 2003 (JP) 2003-145285

(51) Int. Cl. G01C 21/32

(52) U.S. Cl. 701/208; 340/5.74

(57) ABSTRACT

In a navigation device, when a hardware switch is turned “ON” so that Valet mode is “ON,” use of destination designating methods using a memory point and a position of home is prohibited. When the hardware switch is turned “OFF,” a user authentication of a password input is required. When the user authentication is successfully executed, the use of the destination designating methods using the memory point and the point of home become operative. This enables an authorized user to use the destination designating methods using the memory point and the point of home, methods which relate to personal information. By contrast, this prevents an authorized person who does not know the password from accessing the personal information since the authentication is not provided. The leak of the personal information that is registered in the navigation device can be thereby restrained.

### CROSS REFERENCE TO RELATED APPLICATIONS

This application is based on and incorporates herein by reference Japanese Patent Application No. 2003-145285 filed on May 22, 2003.

### FIELD OF THE INVENTION

The present invention relates to an in-vehicle device and method for restraining an unauthorized use.

### BACKGROUND OF THE INVENTION

An in-vehicle device for restraining an unauthorized use is known, e.g., in JP-A-2000-127905. Here, a data carrier stores individual user information pertinent to a vehicle owner as a user; an in-vehicle device retrieves the individual user information from the data carrier to compare it with previously stored information (first authentication). Further, according to the result of comparing, additional individual user information is required to the user for inputting it through the in-vehicle device; the inputted additional individual user information is compared with previously stored user identification information of a user for whom the use of the vehicle is permitted (second authentication); and based on the result of comparing, the inoperative state of the vehicle is released or continued.

Thus, the first authentication verifies the information stored in the data carrier, while the second authentication verifies the user identification information of the authorized user (e.g., electronic finger print information). An unauthorized-use by a person only holding the data carrier can be thereby restrained. For instance, in a hotel, there is a case (a valet parking) where a vehicle owner asks a valet of the hotel to park the vehicle. Here, before asking the valet parking, the above two authentications must be previously completed. The valet can thereby access to information such as personal information registered in an in-vehicle navigation device, involving risk of a leak of privacy.

### SUMMARY OF THE INVENTION

It is an object of the present invention to provide an in-vehicle device or method for restraining an unauthorized use of individual information registered in an in-vehicle device to restrain a leak of it.

To achieve the above object, an in-vehicle device provided in a vehicle is provided with the following. A command is generated for permitting or unpermitting a use of a given function of the in-vehicle device. Based on the generated command, the use of the given function is enabled or disabled. When the command for permitting the use of the given function is generated while the given function is being disabled, an authentication process is executed. After the authentication process is successfully executed, the use of the given function is permitted and enabled.

For instance, this structure enables only an authorized user to use the given function relating to personal information after the authentication process through inputting identification information such as a password. By contrast, this structure prevents an unauthorized person who does not know the password from accessing the users personal information since the authentication is not provided. The leak of the personal information that is registered in the in-vehicle device can be thereby restrained. Here, the given function cannot include a function enabling the vehicle to travel; therefore, even when an unauthorized person is allowed to drive the vehicle, he cannot access the personal information.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram showing a navigation device and its peripherals according to an embodiment of the present invention;

FIG. 2 is a block diagram showing a structure of the navigation device according to the embodiment;

FIG. 3 is a flowchart diagram explaining the former part of the process of restraining an unauthorized use at a destination setting;

FIG. 4 is a flowchart diagram explaining the latter part of the process of restraining an unauthorized use at a destination setting;

FIG. 5A is a diagram showing an example of a display window for a destination setting;

FIG. 5B is a diagram showing an example of a display window for a destination setting;

FIG. 6 is a diagram showing an example of a display window for a password setting; and

FIG. 7 is a diagram showing an example of a display window when Valet mode “ON” is set.

### DETAILED DESCRIPTION OF THE PREFERRED EMBODIMENTS

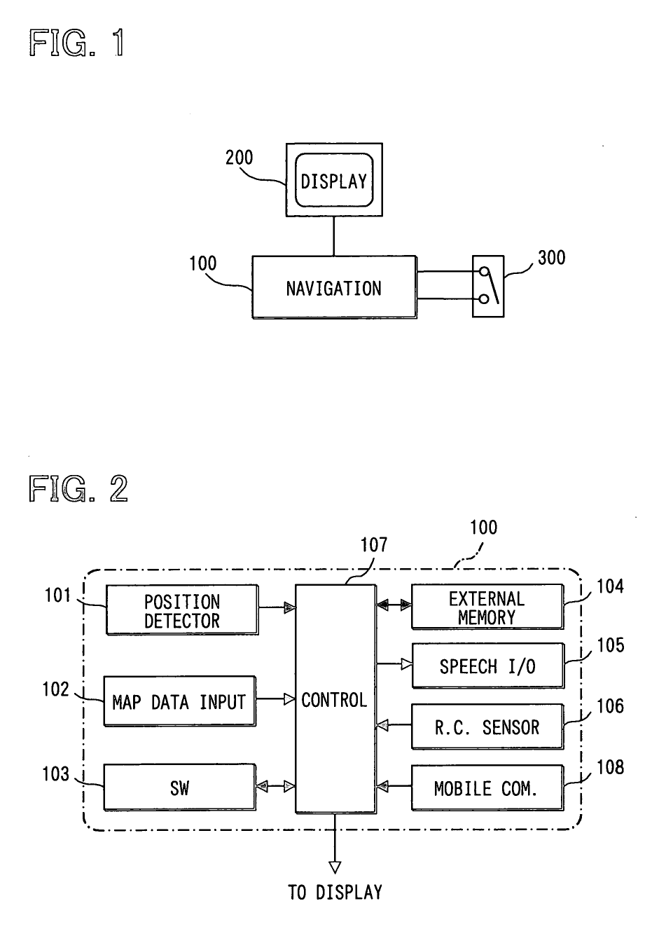

Of the present invention, an in-vehicle device and method for restraining an unauthorized use are directed to a navigation device mounted in a vehicle such as automobile. As shown in FIG. 1, a navigation device 100 is connected with a display 200 and a hardware switch 300.

The display 200 is constructed of, for instance, a liquid crystal display, displaying on its screen a mark of a current vehicle position (current vehicle position mark) and a map surrounding the current vehicle position. The current position is inputted by a position detector 101 (to be explained later) of the navigation device 100. The map is generated using display data inputted by a map data input unit 102.

The hardware switch 300 is used for permitting or unpermitting a use of a given function of the navigation device 100. ON/OFF signals of the hardware switch 300 are transmitted to the navigation device 100.

Referring to FIG. 2, the navigation device 100 includes the position detector 101, a map data input unit 102, a manipulation switch group (SW) 103, an external memory 104, a speech input/output unit 105, a remote controller sensor 106, and a control circuit 107 connected with the foregoing.

The control circuit 107 is constructed of a known computer, including a CPU, a ROM, a RAM, an I/O, a bus line intermediating between the foregoing components. The ROM stores a program executed by the navigation device 100; according to the program, the CPU performs given computations.

The position detector 101 includes known sensors (not shown) as follows: a geomagnetic sensor; a gyroscope; a distance sensor; and a GPS (Global Positioning System) receiver for detecting a current vehicle position based on radio waves from the satellites. Each of these sensors has a different type of error; therefore, several sensors are mutually supplemented with one another for practical use. According to accuracies of the sensors, the position detector 1 can be constructed of only several sensors of them; further, other sensors such as a steering rotation sensor or a wheel speed sensor for each wheel can be adopted.

The map data input unit 102 is for inputting various data such as search data or display data, and for transmitting the various data based on a request of the control circuit 107. The various data is stored in a storage medium such as a CD-ROM or DVD-ROM owing to its data volume. The search data and display data will be explained below.

The search data includes town page data and address data. The town data is formed of facility names, facility genres such as a hotel and station, phone numbers, position coordinates (longitude and latitude), etc. The address data is formed of address names, position coordinates (longitude and latitude), etc. By contrast, the display data is formed of map data, background data, landmark data, etc., being used for displaying a map on a screen of the display 200. Here, the landmark data is formed of names and shapes of landmarks shown on the map, and position coordinates (longitude and latitude).

The map data is formed of link data and node data. Here, an on-map road that is a road shown on a map is divided by nodes where the road intersects with another road, branches, and is merged with another road. A link is then defined to be a line between nodes, being connected with another link to form a road. The link data includes: a unique link ID identifying a link; a link length indicating a length of the link; position coordinates (longitude and latitude) of starting and terminating nodes where the link is started and terminated, respectively; a road name; a road type; a road width; the number of lanes; existence/nonexistence of a lane dedicated for right or left turning; the number of lanes dedicated for right or left turning; and a limit speed.

The node data includes: a node ID uniquely assigned to a node; node coordinates; a node name; connection link IDs connected with the node; and an intersection type.

The manipulation switch group 103 is formed of, e.g., mechanical switches, being used for input such as scrolling of a map shown on a screen of the display 200, inputting a character, and selecting a key.

The external memory 104 includes a large volumetric read/write storage medium such as a memory card or HDD, being used for storing an execution result of the control circuit 107 or a memory point registered by the user.

The speech input/output unit 105 is formed of an input and output units (not shown). The input unit is for recognizing an utterance of a user to input it to the navigation device 100. The output unit is formed of a speaker, an audio amplifier, or the like to be used for speech guidance, etc.

Further, in this navigation device 100, when a destination setting is performed using the manipulation switch group 103 or a remote controller (not shown), a destination setting window shown in FIG. 5A is shown on the screen of the display 200. In this destination setting window, several methods for designating a destination (destination designating methods) are shown; therefore, selecting one of the methods enables designation of a targeted destination.

Moreover, once the destination is designated, the most appropriated travel route from the current position to the destination is automatically selected to form a guidance route (route search function). This function of automatic route search includes, e.g., a cost computation using the known Dijkstra method, where a route having the minimum cost up to the destination is computed using costs assigned to links. Here, each of the costs is computed with a link length, the number of lanes, a road width, etc.

These above functions are executed mainly by the control circuit 107 performing the various computations. Namely, the control circuit 107 computes a route using the display data of the map data input unit 102 once the destination is designated; the computed route is displayed on the display 200; and a branching point or right/left turning intersection is notified by enlarging the corresponding map or performing the speech guidance.

Furthermore, in this navigation device 100, when an output signal of the hardware switch 300 is “ON,” “MEMORY POINT” and “HOME” among the destination designation methods become inoperative (or disabled) while toned down as shown in FIG. 5B. These two destination designating methods become operative (or enabled) when a user is authenticated through inputting a user's password.

In detail, for instance, when a user puts the user's vehicle under valet's charge for parking the vehicle (valet parking), personal information such as a memory point or the position of the home stored in the navigation device 100 can be, without authorization, accessed and varied by any person other than the regular user.

For dealing with the above situation, in the navigation device 100 of this embodiment, the designating methods using the memory point and the position of home become inoperative when the hardware switch 300 is manipulated to become “ON” (Valet mode “ON”). Here, that the hardware switch 300 is manipulated to “ON” or “OFF” means that the command is generated for disabling or enabling the designating methods using the memory point and the position of home, respectively. By contrast, when the hardware switch 300 is switched to “OFF,” a user authentication through the password input is performed. When the authentication is successfully performed, the designating methods using the memory point and the position of home can become operative (Valet mode “OFF”).

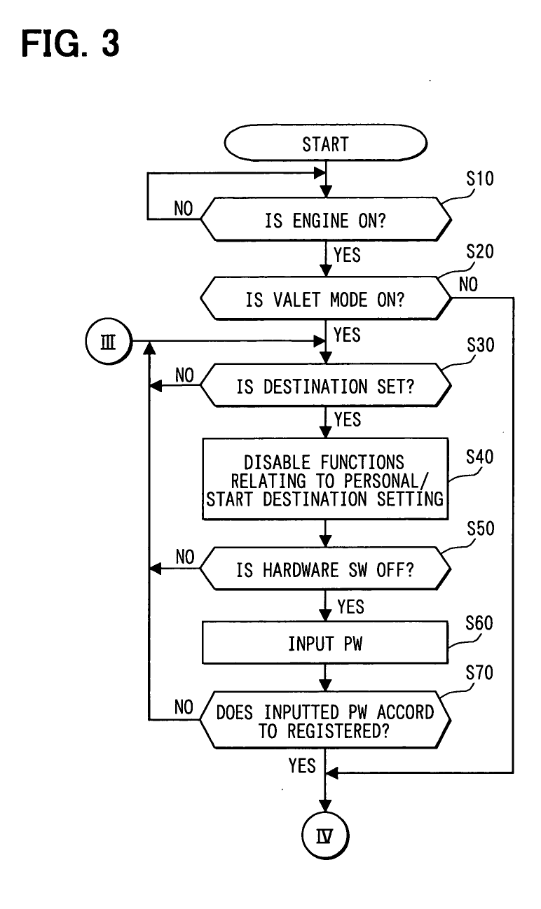

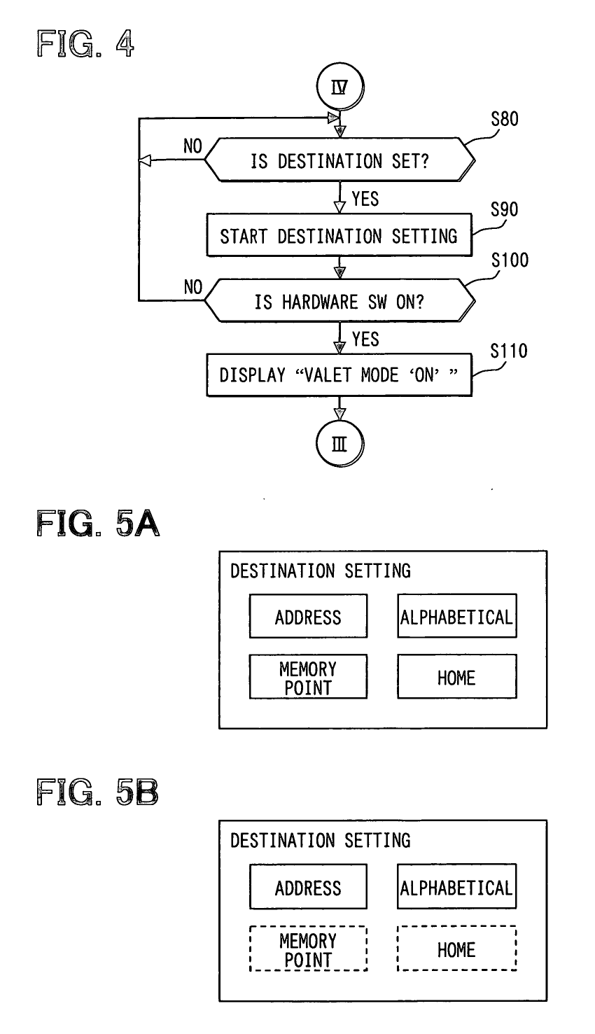

Next, a process for restraining an unauthorized use at the destination setting will be explained below with reference to FIGS. 3, 4.

At Step 10, it is determined whether an engine is turned on. Affirmative determination sends the process to Step 20, while negative puts the process to a waiting state.

At Step 20, it is determined whether Valet mode is “ON.” Affirmative determination sends the process to Step 30, while negative to Step 80 (in FIG. 4) since Valet mode is “OFF.”

At Step 30, it is determined whether a destination setting is performed. Affirmative determination sends the process to Step 40, while negative puts the process to a waiting state.

At Step 40, since Valet mode is “ON,”. “MEMORY POINT” and “HOME” become inoperative while becoming toned down as shown in FIG. 5B. Namely, functions relating to the personal information are disabled and the destination setting is started.

At Step 50, it is determined whether a hardware switch 300 is turned “OFF” by a user. Affirmative determination sends the process to Step 60, while negative to Step 30, where a waiting state continues until the designating method is selected.

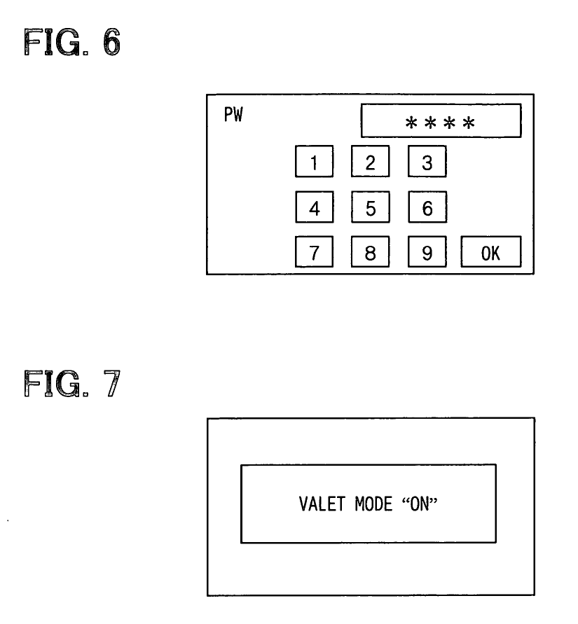

At Step 60, a password input window is shown as shown in FIG. 6; a user is requested for the password input.

At Step 70, it is determined whether the inputted password accords with the password previously registered by the user. Affirmative determination meaning that the user is successfully authenticated sends the process to Step 80, while negative meaning that the user is not authenticated to Step 30.

At Step 80 in FIG. 4, it is determined whether a destination setting is performed. Affirmative determination sends the process to Step 90, while negative puts the process to a waiting state.

At Step 90, since Valet mode is “OFF,” “MEMORY POINT” and “HOME” are operative similarly with other designating methods while being shown in the same manner as that of other designating methods as shown in FIG. 5A.

At Step 100, it is determined a hardware switch 300 is turned “ON” by a user. Affirmative determination sends the process to Step 110, while negative to Step 80, where a waiting state continues until the designating method is selected.

At Step 110, a state of Valet mode is notified to a user, for instance, by displaying “Valet mode ‘ON’” as shown in FIG. 7. Thereafter, the process is sent to Step 30, where the above is to be repeated.

As explained above, in the navigation device 100 of this embodiment, when the hardware switch 300 is turned “ON,” designating methods using the memory point and the position of home are disabled. By contrast, when the hardware switch 300 is turned “OFF,” a user authentication through a password input is performed. When the authentication is successfully performed, the designating methods using the memory point and the position of home become operative.

Thus, the regular authorized user can operate the designating methods relating to the personal information after the password input, while the user not knowing the password cannot operate the designating methods relating to the personal information. This results in restraining the leak of the personal information.

(Modification 1)

In the navigation device 100 of the embodiment, designating methods using a memory point and a position of home can be switched between operative and inoperative states; however, other functions can be switched between them similarly. For instance, the other functions include a function for setting a new memory point, a function for changing setting of a memory point, and a function for retrieving a memory point. Further, the other functions can include any function that is manipulated by a user such as a function for setting or changing setting relating to a scale of map display.

Furthermore, without limiting to a navigation device 100, other devices can adopt the present invention. For instance, the present invention can be directed to a preset function for setting a radio station in an in-vehicle audio unit; a setting function for temperature/air volume in an air conditioner; and a setting function, a changing setting function, and an accessing function for overall in-vehicle devices. Namely, these functions can be switched between operative and inoperative states. This can restrain a person other than an authorized user from tampering personal information, preventing the leak of the personal information.

(Modification 2)

When a navigation device 100 is not provided with a main power (i.e., the navigation device 100 is not activated), a state of Valet mode prior to stop of the main power is preferably maintained. This eliminates need for manipulating the hardware switch 300 to change Valet mode each time the main power is supplied. Further, similarly, when an engine of a vehicle is stopped, a state of Valet mode prior to stop of the engine is preferably maintained. This eliminates need for manipulating the hardware switch 300 to change Valet mode each time the engine is started.

(Modification 3)

In this embodiment, Valet mode switches its state according to the manipulation of the hardware switch 300. However, when a valet key or spare key is used, an instruction that a given function should be disabled can be generated. Here, the valet key or spare key is a key that can start an engine of the vehicle, but cannot open a trunk of the vehicle. In detail, when the spare key is inserted to a key cylinder, key type information that a key type of the inserted key is a spare key is transmitted. The given function then becomes disabled based on the key type information that is obtained via a communications function.

Thus, for instance, when a user puts a spare key of a vehicle under valet's charge in a hotel, etc., for the valet to operate the vehicle, the given function is automatically disabled. Further, by using a voice input having a user authentication function, switching between operative and inoperative states of the given function can be enabled. This relieves a user's manipulation for instruction.

(Modification 4)

In this embodiment, Valet mode switches its state according to the manipulation of the hardware switch 300. However, Valet mode “ON” can be automatically selected each time the position detected by the position detector 101 includes that of a hotel or restaurant where a valet parking is requested.

Here, a position where Valet mode “ON” should be automatically selected can be previously inputted. When the arrival to the previously inputted position is determined by using the position detector 101, Valet mode “ON” can be automatically selected. Otherwise, when an engine is stopped after the arrival to the previously inputted position is determined, Valet mode “ON” can be automatically selected upon determining the restart of the engine.

Further, Valet mode “ON” can be selected by correlating with a destination designated at route guidance. Namely, when the arrival to the previously designated destination at the route guidance is determined, Valet mode “ON” can be automatically selected. Otherwise, when an engine is stopped after the arrival to the previously designated destination is determined, Valet mode “ON” can be automatically selected upon determining the restart of the engine.

Further, additional information that enables Valet mode “ON” can be stored by correlating with facility information such as a hotel or a restaurant in the map data. Namely, when a position having the additional information is designated as a destination and the arrival to the destination is determined, Valet mode “ON” can be automatically selected based on the additional information. Otherwise, when an engine is stopped after the arrival to the destination is determined, Valet mode “ON” can be automatically selected upon determining the restart of the engine.

The above structures eliminates a user's manipulation of the hardware switch 300, automatically selecting Valet mode “ON.”

(Modification 5)

The navigation device 100 of this embodiment can be equipped with a mobile communications unit 108 (shown in FIG. 2) that transmits a vehicle current position detected by the position detector 101 when Valet mode “ON” is selected. For instance, when a hotel adopts a parking managing system, the vehicle current position can be sent to the parking managing system. This enables the parking managing system to grasp the parking position of the customer's vehicle whose valet parking is asked.

Further, the vehicle current position is sent to a cell phone of a regular user or owner of the vehicle so that the sent current position and the map surrounding the current position can be displayed on the screen of the cell phone. The user can thereby confirm that the vehicle is surely parked in the parking lot.

Further, door-lock states of the doors of the vehicle are externally sent so that the door-lock states can be remotely confirmed. When the movement of the vehicle to a place such as a parking lot in a hotel is asked to other persons, the user can confirm the door-lock states of the vehicle that is parked in the parking lot.

(Modification 6)

In this embodiment, when a radio set or other in-vehicle devices are power-supplied by itself without using a vehicle battery, they can be activated without identifying the user. Here, it is designed that a given function is disabled by an instruction of prohibiting the use of the given function.

For instance, it is supposed that a vehicle is a type where a radio set or navigation device can activated without inserting a key. Here, it can be designed that a given function is disabled while the user is not authenticated.

It will be obvious to those skilled in the art that various changes may be made in the above-described embodiments of the present invention. However, the scope of the present invention should be determined by the following claims.

What is claimed is:

1. An in-vehicle device provided in a vehicle, comprising:
a commanding unit for generating a command of one of a permitting command for permitting a use of a given function of the in-vehicle device and an unpermitting command for unpermitting the use of the given function;
a controlling unit for executing one of enabling and disabling the use of the given function;
an authenticating unit for executing an authentication process when the permitting command is generated by the commanding unit while the given function is being disabled,
wherein, when the authentication process is successfully executed by the authenticating unit, the controlling unit executes enabling the use of the given function.

2. The in-vehicle device of claim 1,
wherein the given function includes a function for setting, a function for changing setting, and a function for browsing setting contents.

3. The in-vehicle device of claim 1,
wherein the authenticating unit includes:
an inputting unit for inputting individual information unique to a user of the vehicle; and
a registry storing unit for storing registry information registered by the user, and
wherein the authenticating unit successfully executes the authentication process when a given relationship between the individual information and the registry information is fulfilled.

4. The in-vehicle device of claim 1,
wherein, when a power supplied to the in-vehicle device is stopped, the controlling unit retains one of enabling and disabling the use of the given function that is executed by the controlling unit just before the power is stopped.

5. The in-vehicle device of claim 1,
wherein, when a spare key is inserted to a key cylinder of the vehicle, the commanding unit generates the unpermitting command for unpermitting the use of the given function.

6. The in-vehicle device of claim 1, further comprising:
a map data storing unit for storing map data including position information relating to positions of facilities on a map; and
a position detector for detecting a current position,
wherein, when a current position detected by the position detector is a position of a given facility, the commanding unit generates the unpermitting command for unpermitting of the use of the given function.

7. The in-vehicle device of claim 1,
wherein, when the in-vehicle device is able to be powered without inserting a key to a key cylinder of the vehicle, the commanding unit generates the unpermitting command for unpermitting the use of the given function while the in-vehicle device is powered without inserting the key to the key cylinder.

8. The in-vehicle device of claim 1, further comprising:
a position detector for detecting a current position; and
a transmitter for transmitting the current position detected by the position detector to an outside when disabling the use of the given function is executed by the controlling unit.

9. The in-vehicle device of claim 1,
wherein the given function dose not include a function enabling the vehicle to travel.

10. The in-vehicle device of claim 1,
wherein the in-vehicle device includes a navigation device.

11. An unauthorized-use restraining method for an in-vehicle device provided in a vehicle, comprising steps of:
disabling a use of a given function of the in-vehicle device based on a command for unpermitting the use of the given function;
executing an authentication process based on a command of permitting the use of the given function while the given function is being disabled; and
enabling the use of the given function when the authentication process is successfully executed.

12. The unauthorized-use restraining method of claim 11,
wherein the given function dose not include a function enabling the vehicle to travel.

13. A vehicular control device for controlling an in-vehicle device provided in a vehicle, comprising:
a determining unit for determining one of permitting and unpermitting a use of a given function of the in-vehicle device, the given function which is not necessarily required for traveling of the vehicle; and
a controlling unit for causing, when the determining unit determines unpermitting the use of the given function, a prohibition state where the use of the given function is prohibited,
wherein the traveling of the vehicle is permitted in the prohibition state, and
wherein the prohibition state caused by the controlling unit is continued until the prohibition state is released.

14. The vehicular control device of claim 13,
wherein the given function that is not necessarily required for the traveling of the vehicle includes a function enabling the vehicle to run, turn and stop.

15. The vehicular control device of claim 13, further comprising:
an authenticating unit for providing an authentication by successfully executing an authentication process when permitting the use of the given function is determined by the determining unit,
wherein, when the authentication is provided by the authenticating unit after the authentication process is successfully executed, the prohibiting state is released.

16. The vehicular control device of claim 15,
wherein the authenticating unit includes:
an inputting unit for inputting individual information unique to a user of the vehicle; and
a registry storing unit for storing registry information registered by the user, and
wherein the authentication process is successfully executed when it is determined that a given relationship between the individual information and the registry information is fulfilled.

17. The vehicular control device of claim 13,
wherein the given function includes a function for setting, a function for changing setting, and a function for browsing setting contents of the in-vehicle device.

18. The vehicular control device of claim 13,
wherein, even when a power supplied to the vehicular control device and the in-vehicle device is stopped, the prohibition state caused by the controlling unit is retained at earliest till the power re-starts to be supplied to the vehicular control device and the in-vehicle device.

19. The vehicular control device of claim 13,
wherein, when a spare key is inserted to a key cylinder of the vehicle, the determining unit determines unpermitting the use of the given function.

20. The vehicular control device of claim 13, further comprising:
a map data storing unit for storing map data including position information relating to positions of facilities on a map; and
a position detector for detecting a current position,
wherein, when a current position detected by the position detector is a position of a given facility, the determining unit determines unpermitting the use of the given function.

21. The vehicular control device of claim 13,
wherein, when the vehicular control device and the in-vehicle device are able to be powered without inserting a key to a key cylinder of the vehicle, the determining unit determines unpermitting the use of the given function while the vehicular control device and the in-vehicle device are powered without inserting the key to the key cylinder.

22. The vehicular control device of claim 13, further comprising:
a position detector for detecting a current position; and
a transmitter for transmitting the current position detected by the position detector to an outside when the prohibition state is caused by the controlling unit.

23. The vehicular control device of claim 13,
wherein the in-vehicle device includes a navigation device.

24. An unauthorized-use restraining method for an in-vehicle device provided in a vehicle, comprising steps of:
determining unpermitting a use of a given function of the in-vehicle device, the given function which is not necessarily required for traveling of the vehicle;
causing, when unpermitting the use of the given function is determined, a prohibition state where the use of the given function is prohibited although the traveling of the vehicle is permitted; and
continuing the caused prohibition state until the prohibition state is released.

25. The unauthorized-use restraining method of claim 24, further comprising steps of:
determining permitting the use of the given function while the use of the given function is being prohibited;
executing an authentication process after permitting the use of the given function is determined;
providing an authentication after the authentication process is successfully executed; and
releasing the prohibition state.
